(19) United States
(12) Patent Application Publication
(10) Pub. No.: US 2016/0305413 A1
(43) Pub. Date: Oct. 20, 2016

(54) PRESSURE VESSEL GRADED MEDIA FOR HEAT EXCHANGE IN A COMPRESSION SYSTEM

(71) Applicant: EATON CORPORATION, Cleveland, OH (US)

(72) Inventor: Edward John HUMMELT, Greenfield, WI (US)

(21) Appl. No.: 14/783,628

(22) PCT Filed: Apr. 10, 2014
(86) PCT No.: PCT/US2014/033635

§ 371 Date: Oct. 9, 2015

Related U.S. Application Data
(60) Provisional application No. 61/811,571, filed on Apr. 12, 2013.
(60) Provisional application No. 61/845,687, filed on Jul. 12, 2013.

(51) Int. Cl. F04B 39/06; F04B 39/12; F17C 1/00; F28D 17/00; F28D 17/02; F04B 37/18; F04B 39/00

(52) U.S. Cl. CPC F04B 39/06; F04B 37/18; F04B 39/12; F04B 39/0011; F28D 17/005; F28D 17/02; F17C 1/00; F28D 2021/0047

(57) ABSTRACT

A system for compressing gas includes a source of gas, a gas output location, first and second pressure vessels, first and second gas input lines for directing gas from the source of gas respectively to the first and second pressure vessels, first and second gas output lines for directing gas respectively from the first and second pressure vessels to the gas output location, and a hydraulic system for moving hydraulic fluid back and forth between the first and second pressure vessels to compress gas in the first and second pressure vessels in an alternating manner. Gas is pressurized in the first pressure vessel and the second pressure vessel. A heat absorbing media is positioned within the first and second pressure vessels to control an amount the gas increases in temperature during compression.

### CROSS-REFERENCE TO RELATED APPLICATION(S)

This application is being filed on 10 Apr. 2014, as a PCT International Patent application and claims priority to U.S. Patent Application Ser. No. 61/811,571 filed on 12 Apr. 2013, and U.S. Patent Application Ser. No. 61/845,687 filed on 12 Jul. 2013, the disclosures of which are incorporated herein by reference in their entireties.

### INTRODUCTION

The need for highly pressurized gasses is growing. This is particularly true with the advent of natural gas vehicles, which depend on highly compressed natural gases instead of fossil fuels for operation. In compressing such gases, high compression pressure ratios, on the order of 200/1 or more, are commonly encountered. Such high pressure ratios require multistage compressors with intercooling, or if done in a single stage, lead to significant heat production, which can often times reduce the efficiency of the compression process.

### SUMMARY

In one embodiment, a system for compressing gas is described. The system includes a source of gas; a gas output location; first and second pressure vessels; first and second gas input lines for directing gas from the source of gas respectively to the first and second pressure vessels; first and second gas output lines for directing gas respectively from the first and second pressure vessels to the gas output location; a hydraulic system for moving hydraulic fluid back and forth between the first and second pressure vessels to compress gas in the first and second pressure vessels in an alternating manner, wherein gas is pressurized in the first pressure vessel by directing a first charge of gas from the source of gas into the first pressure vessel through the first gas input line and moving hydraulic fluid from the second pressure tank to the first pressure tank to compress the first charge of gas within the first pressure vessel, and wherein gas is pressurized in the second pressure vessel by directing a second charge of gas from the source of gas into the second pressure vessel through the second gas input line and moving hydraulic fluid from the first pressure tank to the second pressure tank to compress the second charge of gas within the second pressure vessel; and wherein a heat absorbing media is positioned within the first and second pressure vessels to control an amount the gas increases in temperature during compression. In another embodiment, a method for compressing gas is disclosed. The method includes: directing a charge of gas to a pressure vessel having a bed of heat sink media; moving hydraulic fluid into the pressure vessel to compress the gas; and absorbing heat of compression with the heat sink media as the gas is compressed. Pressure sensors can be provided at the compressed gas tank and/or at the first and second pressure vessels. Valves, pumps and other structures can be used to control hydraulic fluid flow and gas flow within the system.

In certain examples, the graded media provides a relatively large surface area in areas of higher compression and thus, provides the thermal mass that facilitates the effective transfer of heat from the compressed gas to the media during the compression process. In this way, the graded media function as heat sinks for absorbing heat during gas compression thereby limiting the temperature rise of the gas during compression. Ideally, the heat sink function provided by the graded media allows the compression process to take place in a more isothermal manner thereby improving the compression efficiency. The heat absorbed by the graded media may absorbed by the media can be transferred from the media to the hydraulic fluid. A heat exchanger can be used to remove heat from the hydraulic fluid as the hydraulic fluid is moved between the first and second pressure vessels.

In yet another embodiment, a pressure vessel is disclosed. The pressure vessel includes a heat sink media contained in the pressure vessel. The pressure vessel may be arranged and configured to receive a charge of gas and a volume of hydraulic fluid, wherein the volume of hydraulic fluid compresses the charge of gas thereby resulting in an output of heat, and wherein the heat sink media absorbs a portion of the heat and releases the portion of the heat into the hydraulic fluid.

These and various other features as well as advantages which characterize the systems and methods described herein will be apparent from a reading of the following detailed description and a review of the associated drawings. Additional features are set forth in the description which follows, and in part will be apparent from the description, or may be learned by practice of the technology. The benefits and features of the technology will be realized and attained by the structure particularly pointed out in the written description and claims herein as well as the appended drawings.

It is to be understood that both the foregoing general description and the following detailed description are exemplary and explanatory and are intended to provide further explanation for the appended claims.

### BRIEF DESCRIPTION OF FIGURES

FIG. 1 is an illustration of an embodiment of a gas compression system.

FIG. 2A is an illustration of an embodiment of a gas compression system having a gas compression circuit. The gas compression system is shown transferring hydraulic fluid from a first pressure vessel to a second pressure vessel to cause a charge of natural gas to be compressed within the second pressure vessel.

FIG. 2B shows the gas compression system of FIG. 2A with the hydraulic fluid being transferred from the second pressure vessel to the first pressure vessel to cause a charge of natural gas to be compressed within the first pressure vessel.

FIG. 3 is a graph illustrating example relationships between time and gas temperature in an example compression system.

FIG. 4 is an illustration of one embodiment of a pressure vessel filled with a graded media.

FIG. 5 is an illustration of another embodiment of a pressure vessel filled with a graded media.

FIGS. 6A and 6B are illustrations of alternative embodiments of a graded media.

FIG. 7 is a flow diagram representing an embodiment of a method for compressing gas.

### DETAILED DESCRIPTION

In general, the embodiments herein describe methods and systems for gas compression. In some embodiments, the gas compression system described herein can be used in connection with a natural gas vehicle, in which a compressed natural gas (“CNG”) is used as an alternative to fossil fuels. For example, the gas compression system includes a hydraulic system that can be selectively coupled (e.g., by a hose coupling) to a CNG tank used to power a natural gas vehicle. Due to needs for high-pressure (sometimes greater than 1500 psi or in the range of 1500-5000 psi) gas in this and other situations, the gas compression system described herein utilizes one or more compression chambers each including graded media having a relatively high surface area and thermal mass. The relatively high surface area and thermal mass provided by the graded media allows the media to function as heat sinks for absorbing heat from the natural gas during the compression process. This allows the compression process to operate in a more isothermal manner thereby allowing better compression efficiencies to be achieved. Heat absorbed by the media may be transferred through an intermediate working fluid to the exterior environment.

Grading allows the media to have a higher surface area and thermal mass at the regions where the compressed natural gas will be most highly compressed and most subject to significant increases in temperature. Grading allows the system to address temperature increase while still minimizing the overall weight of thermal media used and the overall volume of the pressure vessels. It is understood that though the terms “graded” and “gradient” are used herein, a gradual linear change in media size is not necessary. In some embodiments, the graded media may change in a stepwise fashion or in other non-linear manners.

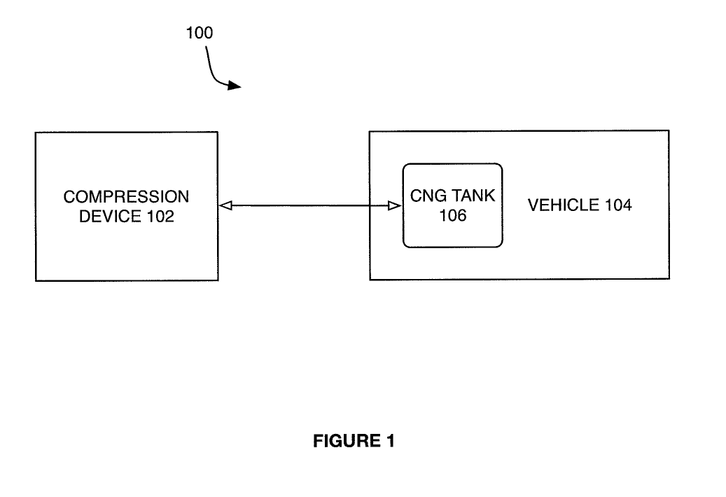

Referring now to FIG. 1, an example embodiment of a gas compression system 100 is shown. The system 100 includes a compression device 102 and a natural gas vehicle 104. The vehicle 104 includes a CNG tank 106. In general, FIG. 1 illustrates one embodiment of the system 100 in which the compression device 102 is selectively connected to the CNG tank 106 for the purpose of compressing natural gas and delivering the compressed natural gas to the vehicle 104. In one example, the compression device 102 can be provided at a tank filling location (e.g., a vehicle owner's garage, a natural gas filling station, etc.). To reduce the space occupied by the compression device as well as the cost of the compression device, it is desirable for the overall size of the compression device to be minimized. In use, the vehicle may park at the filling location at which time the compression device 102 is connected to the CNG tank 106 and used to fill the CNG tank 106 with compressed natural gas. In certain examples, the filling/compression process can take place over an extended time (e.g., over one or more hours or overnight). After the CHG tank 106 has been filled with compressed natural gas having a predetermined pressure level, the compression device 102 is disconnected from the CNG tank 106 and the vehicle is ready for use. In some embodiments, the system is capable of outputting a maximum gas pressure less than or equal to 4500 psi. In yet further embodiments, the system is capable of outputting a maximum gas pressure less than or equal to 4000 psi.

The vehicle 104 is a natural gas vehicle that includes the CNG tank 106. The vehicle 104 is powered by a compressed natural gas. In some embodiments, as shown, the CNG tank 106 is located within the vehicle 104 or otherwise carried by the vehicle 104. It is understood that in some examples, the vehicle 104 may include more than one CNG tank 106 which are each configured to be coupled to the compression device 102. In other embodiments, the compression device 102 can fill and intermediate CNG tank that is then used to fill CNG 106 carried by the vehicle 104.

The compression device 102 is arranged and configured to compress a volume of gas to relatively high pressures, for example, pressures greater than 2000 psi. In certain examples, the pressure ratio can be greater than 200/1. The compression device 102 utilizes a supply of natural gas and compresses the gas to a desired pressure. The compressed gas is delivered to the CNG tank 106 within the vehicle 104. In some embodiments, the supply of natural gas is provided as part of the compression device 102; however, in other embodiments, the supply of natural gas is external to the compression device 102. In certain examples, the supply of natural gas can be provided by a natural gas supply tank or a natural gas line that provides natural gas from a utility.

As will be described in greater detail below, the compression device 102 utilizes one or more pressure vessels for pressurizing the natural gas. The pressure vessels can be any size, but in some embodiments, the pressure vessels have a volume of less than 10 liters. During operation of the system 100, various components of the compression device 102 may be subject to temperature increases due to the heat generated in the pressurizing process. The pressure vessels in the compression device 102 utilize a bed of graded media for heat exchange and release in an effort to meet both the thermal mass and structural pressure containment needs of the compression process.

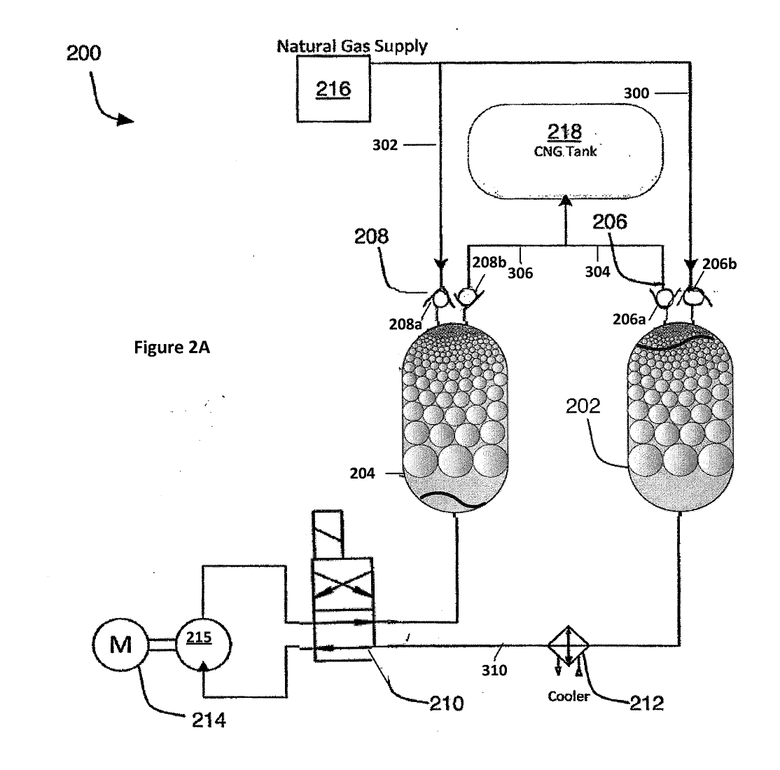

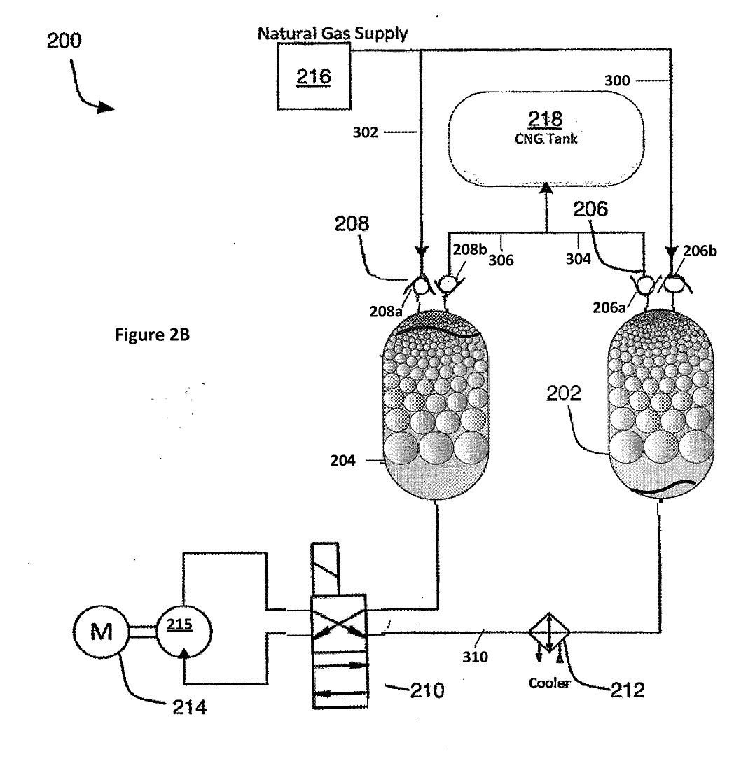

Referring now to FIGS. 2A and 2B, an example embodiment of a gas compression system 200 is shown. The gas compression system 200 includes a first pressure vessel 202, a second pressure vessel 204, a first set of valves 206, a second set of valves 208, a hydraulic fluid valve 210 (e.g., a two-position spool valve) , a cooler 212, a motor 214 and a hydraulic pump 215. The gas compression system 200 is configured to interface with a natural gas supply 216 and a CNG tank 218. For example, the gas compression system can receive natural gas from the natural gas supply 216, and can deliver pressurized natural gas to the CNG tank 218. First and second natural gas input lines 300, 302 (i.e., vessel charge lines) direct natural gas from the natural gas supply 216 respectively to the first and second pressure vessels 202, 204. First and second natural gas output lines 304, 306 direct compressed natural gas from respectively from the first and second pressure vessels 202, 204 to the CNG tank 218. The first and second natural gas output lines 304, 306 can merge together and terminate at a fluid coupling (e.g., a hose coupling) used to selectively connect and disconnect the output lines 304, 306 to and from the CNG tank 218 as needed.

The first set of valves 206 can include one-way check valves 206a, 206b and the second set of valves 208 can include one-way check valves 208a, 208b. The one way check-valves 206a, 208a allow natural gas from the input lines 300, 302 to enter the pressure vessels 202, 204 while preventing the compressed natural gas from within the pressure vessels 202, 204 from back-flowing from pressure vessels 202, 204 through the input lines 300, 302 during gas compression. The one way check-valves 206b, 208b allow compressed natural gas to exit the pressure vessels 202, 204 through the output lines 304, 306 during gas compression while preventing compressed natural gas from CNG tank 218 from back-flowing into the pressure vessels 202, 204 through the output lines 304, 306.

The first and second pressure vessels 202, 204 are hydraulically connected by a hydraulic line 310. The cooler 212 (e.g., a heat exchanger) is positioned along the hydraulic line 310 and functions to extract heat from hydraulic fluid passing through the hydraulic line 310 such that the hydraulic fluid is cooled. The extracted heat can be transferred to the environment. The motor 214 and pump 214 input energy into the system for moving the hydraulic fluid through the hydraulic line 210 between the pressure vessels 202, 204 and for generating a hydraulic piston effect within the pressure vessels 202, 204 for compressing the natural gas within the pressure vessels 202, 204. The hydraulic valve 210 is positioned along the hydraulic line 310 and functions to control/alternate the direction in which the hydraulic fluid is pumped by the pump 215 through the hydraulic line 310 between the pressure vessels 202, 204.

In general, the gas compression system 200 receives natural gas from the natural gas supply 216 and alternatingly directs the gas through each of the first and second pressure vessels 202, 204 to pressurize the natural gas. The pressurized gas is delivered to the CNG tank 218. As stated above, in some embodiments, the CNG tank 218 can be located within a natural gas vehicle, such as the vehicle 104.

FIGS. 2A and 2B show the gas compression system 200 in first and second operating stages of a compression operating cycle. In the first operating state of FIG. 2A, the first pressure vessel 202 is filled with hydraulic fluid and the second pressure vessel 204 does not contain hydraulic fluid or is substantially void of hydraulic fluid.

The hydraulic fluid can be selected from any number of fluids which have relatively low vapor pressures. Other qualities that are favorable in the hydraulic fluid include, for example, low absorptivity and solubility of component gases, chemically inert, constant viscosity (e.g., a viscosity index greater than 100), and/or having a pour point of less than 40 degrees Celsius. Some examples of suitable fluids include: glycols, highly refined petroleum based oils, synthetic hydrocarbons, silicone fluids, and ionic fluids. It is understood that this list is merely exemplary, and other fluids may be utilized.

When in the first state, a charge of natural gas is directed from the natural gas supply 216, through the second input line 302 and the check valve 208a into the second pressure vessel 204. Once the charge of natural gas has been supplied to the second pressure vessel 204, the hydraulic fluid valve 210 is moved to a first position (see FIG. 2A) in which the pump 215 pumps hydraulic fluid through the hydraulic line 310 from the first pressure vessel 202 to the second pressure vessel 204. As the second pressure vessel 204 fills with hydraulic fluid, the hydraulic fluid functions as a hydraulic piston causing the charge of natural gas within the second pressure vessel 204 to be compressed. Once the pressure within the second pressure vessel 204 exceeds the pressure in the CNG tank 218, compressed natural gas from the second pressure vessel 204 begins to exit the second pressure vessel 204 through the check valve 208b and flows through the output line 306 to fill/pressurize the CNG tank 218. This continues until the second pressure vessel 204 is full or substantially full of hydraulic fluid and all or substantially all of the charge of natural gas has been forced from the second pressure vessel 204 into the CNG tank 218. At this point, the gas compression system 200 is at the second operating state of FIG. 2B and the first pressure vessel 202 is void or substantially void of hydraulic fluid. When in the second state of FIG. 2B, a charge of natural gas is directed from the natural gas supply 216, through the first input line 300 and the check valve 206a into the first pressure vessel 202. Once the charge of natural gas has been supplied to the first pressure vessel 202, the hydraulic fluid valve 210 is moved to a second position (see FIG. 2B) in which the pump 215 pumps hydraulic fluid through the hydraulic line 310 from the second pressure vessel 204 to the first pressure vessel 202. As the first pressure vessel 202 fills with hydraulic fluid, the hydraulic fluid functions as a hydraulic piston causing the charge of natural gas within the first pressure vessel 202 to be compressed. Once the pressure within the first pressure vessel 202 exceeds the pressure in the CNG tank 218, compressed natural gas from the first pressure vessel 202 begins to exit the first pressure vessel 202 through the check valve 206b and flows through the output line 304 to fill/pressurize the CNG tank 218. This continues until the first pressure vessel 202 is full or substantially full of hydraulic fluid and all or substantially all of the charge of natural gas has been forced from the first pressure vessel 202 into the CNG tank 218. At this point, the gas compression system 200 is back at the first operating state of FIG. 2A and the second pressure vessel 204 is void or substantially void of hydraulic fluid.

During a normal charging sequence/operation, it will be appreciated that the gas compression system 200 will be repeatedly cycled between the first and second operating states until the pressure within the CNG tank 218 is fully pressurized (i.e., until the pressure within the CNG tank 218 reaches a desired or predetermined pressure level). Though not shown, it is understood that one or more pressure sensors may be positioned at the CNG tank 218, along the output lines 304, 306 and/or at the pressure vessels 202, 204 for monitoring system pressures. It will be appreciated that a controller (e.g., an electronic controller) can be provided for controlling operation of the system. The controller can interface with the various components of the system (e.g., pressure sensors, valves, pump, motor, etc.). In some embodiments, the pump 215 can be bi-directional. In such embodiments, the spool valve 210 can be eliminated.

It will be appreciated that as the natural gas is compressed, the temperature increases. Such increases in temperature can negatively affect efficiency. For example, if the pressurized natural gas provided to the CNG tank has a temperature higher than ambient air, the pressure in the CNG tank will drop as the natural gas in the CHG tank cools. Thus, during charging, the CNG tank will need to be charged to a significantly higher pressure to compensate for the anticipated pressure drop which takes place when the natural gas in the CNG tank cools. In this regard, aspects of the present disclosure relate to enhancing the thermal transfer characteristics of the compression system 200 to inhibit the natural gas within the pressure vessels 202, 204 from increasing significantly in temperature during compression. In this way, the system can operate as close as possible to an isotheral system.

To enhance the thermal transfer properties of the pressure vessels 202, 204, the pressure vessels 202, 204 can each include a plurality of graded media that contact the natural gas during compression. The graded media provide an increased thermal mass and surface area in areas subject to higher compression rates for absorbing heat in the areas of higher compression for allowing the heat to be quickly transferred from the natural gas to the thermal mass. Heat from the thermal mass of the graded media can be transferred to the hydraulic fluid as the hydraulic fluid contacts the exposed surface area of the media during filling of the pressure vessels 202, 204. In certain examples, compression heat removed from the media by the hydraulic fluid can be removed from the system as the hydraulic fluid passes through the cooler 212.

In particular, the graded media addresses the problem of heating that exists towards the end of compression cycles within pressure vessels 202, 204 when compression energy is released into a decreasing volume of gas in a smaller surface area. More specifically, as fluid enters the vessels 202, 204, the fluid level increases which compresses the gas, thereby decreasing the volume of gas and the surface area. The graded media accomplishes a more effective heat exchange by utilizing higher media surface area located in the region of highest compression (i.e., at the upper regions of the pressure vessels near the gas outlets) to facilitate heat transfer between the gas and the hydraulic fluid.

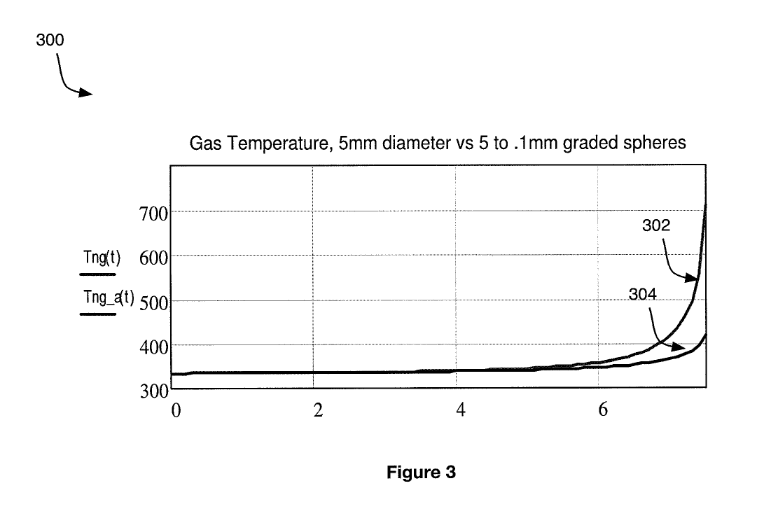

Referring now to FIG. 3, a graph 300 illustrating the relationship between time and gas temperature is shown. In particular, the graph 300 includes a first line 302 representing the change of gas temperature over time when constant media is utilized in a pressure vessel, and a second line 304 representing the change of gas temperature over time when graded media is utilized in a pressure vessel. A pressure vessel may include the pressure vessels 202, 204 shown in FIG. 2 or any other pressure vessel utilized to compress a gas.

The first line 302 assumes a bed of constant spherical media positioned throughout the volume of a pressure vessel. Each of the spherical media includes a 5 mm diameter. The second line 304 assumes a bed of linearly graded spherical media varying in diameter from 5 to 0.1 mm diameters, with the smaller diameter media positioned at the top of the pressure vessel.

As shown, the second line 304 shows a gas temperature rise of approximately 86 degrees Celsius while the first line 302 shows a temperature rise of nearly 379 degrees Celsius. In particular, both the first and second lines 302, 304 appear to have a roughly identical change in temperature over time until about 5 seconds. However, as the volume of the gas within the pressure vessel decreases over time, the constant media is not able to, as effectively, absorb the resulting heat. As shown via the second line 304, a graded media, which is positioned such that media with a smaller diameter is located in the area of higher compression, is able to absorb a significantly greater amount of resulting heat than constant media.

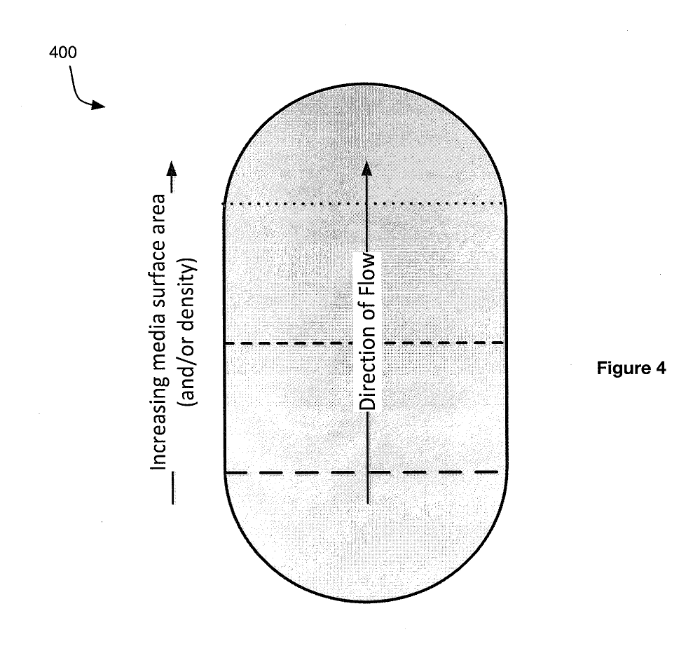

Referring now to FIG. 4, a schematic illustration of a pressure vessel 400 is shown. The pressure vessel 400 is shaded to represent an increasing media surface area and/or density. In particular, to achieve the most efficient heat exchange, media having a greater surface area and/or density should be positioned in the areas of higher compression. In the present example, where hydraulic fluid is filled into a vertical pressure vessel 400, the area of higher compression exists at the top of the pressure vessel 400. Thus, the media should be positioned such that the surface area of the media increases in the direction of flow so that media with the greatest surface area and/or density is located at the area of highest gas compression.

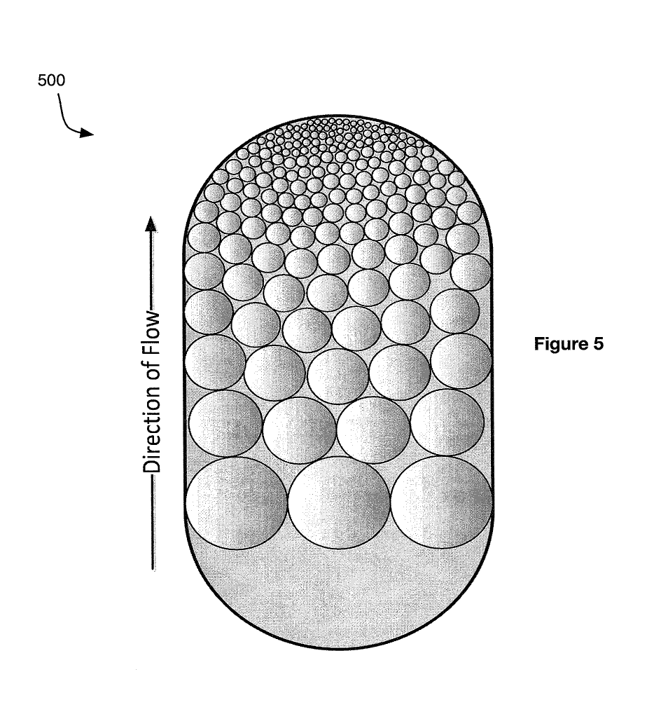

Referring now to FIG. 5, a pressure vessel 500 filled with a graded media is shown. The pressure vessel 500 follows the structure set forth in the pressure vessel 400. In particular, the media is positioned such that the media of smaller diameter are located at the area of highest compression. Though the pressure vessel 500 is shown as having spherical particles, it is understood that a wide range of geometries may be utilized as graded media, such as, for example, foams, wires, saddles, hexagons, squares, rectangles, or packing materials of virtually any shape and configuration. In addition, it is also understood that these various forms of media can be combined in the vessel so as to achieve the optimum combination of surface area and thermal mass, in a graded fashion, throughout the volume of the pressure vessel. The graded media may be solid or hollow, depending on the application. The graded media may also be pellets of material.

Dividers such as screens can be used to separate regions of the vessels that are filled with media having different sizes. While the particle size is shown varying continuously/constantly (i.e., continuously increasing in size from bottom to top), in other examples, the vessel may be divided into different zones/sections with the different zones/sections each containing media of different particle size. In such examples, zones containing smaller particles (i.e., elements units, pellets, pieces, etc.) can be positioned closer to the top of the vessel as compared to zones containing larger particles (i.e., elements, units, pieces, pellets, etc.). In this way, the particle size variation has a more stepped configuration. The particle size (i.e., the average particle cross-dimension) can also vary generally along a curve that generally matches a compression rate curve for the vessel. Alternatively, the particle size can vary linearly. It will be appreciated as the average media particle size gets smaller, the surface area to unit volume ratio increases.

In some embodiments, a packed bed of spherical particles may have some advantages over other shapes of media. For example, the convex surfaces of the spherical particles promote flow and the exclusion of gases without trapping gas pockets as fluid repeatedly fills and vacates the pressure vessel 500. Further, the spherical particles do not affect orientation sensitivity to flow direction and gravity. Next, the spherical particles are inherently repeatable and have acceptable pore space at roughly 64% volume fraction (with 36% voids) for closely packed spheres. Spherical media also provide relatively low flow resistance per unit surface area of the packed bed of media. Additionally, surface area to media thermal mass is easily adjustable through a diameter change in the spherical media. Further, spherical media can be efficiently manufactured in high volume via techniques such as falling shot tower, to generate spheres of the same size. Finally, production of hollow spheres with uniform wall thickness is possible.

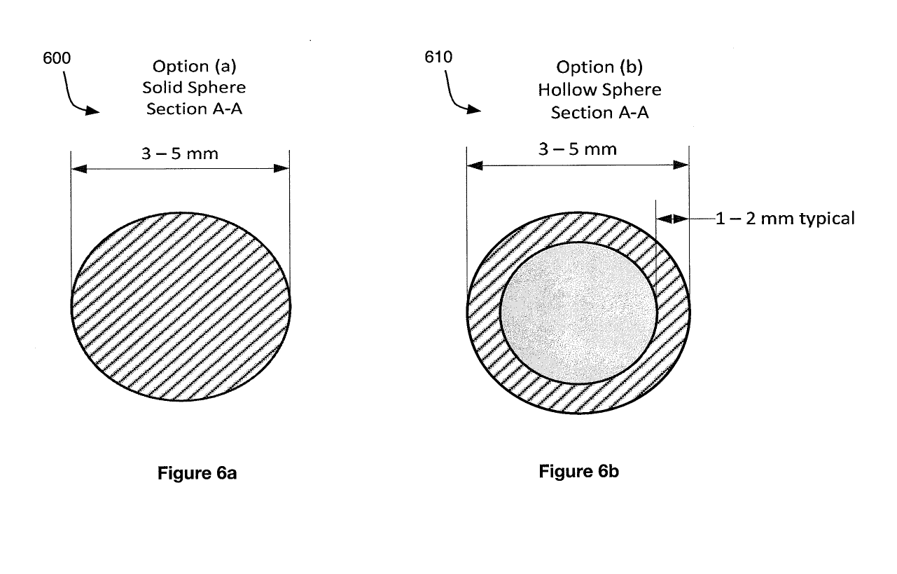

Referring now to FIGS. 6A and 6B, alternate sphere options for graded media is shown. More specifically, FIG. 6A depicts a solid sphere 600 and FIG. 6B depicts a hollow sphere 610.

In general, as described above, both spheres 600 and 610, when filled with graded surface area throughout a pressure vessel, facilitate heat transfer between the gas and working fluid (e.g., hydraulic fluid). The media absorbs heat in real time during the gas compression process, and then releases the heat to the compression liquid as the fluid flows around and contacts the media. The heat is removed from the system as the fluid exists the pressure vessel and draws in fresh gas for the next compression cycle.

As shown in FIGS. 6A and 6B, the media may be solid or hollow based on application needs. For example, a hollow media may be utilized for high absorption efficiency at lighter weights. The hollow spheres are effective since during a normal compression sequence, only the open portions of the spheres have time to absorb heat. In addition, the system may utilize media of various material compositions that are chemically inert with respect to the chemical constituents of the natural gas and compression fluid that is chosen. Materials include, for example, thermally conductive metals, ceramics, and polymers with the polymers preferentially but not necessarily filled with fillers that improve thermal conductivity and heat capacity. Desirable properties for the media material include, for example, high thermal conductivity and high heat capacity, although media thickness can be used to compensate for a lack in either property. For example, in some embodiments, solid spheres having a diameter in the range of 3-5 mm for the largest sphere size and having a diameter on the order of 100 microns for the smallest sphere size may be utilized in some applications. In applications where the spheres are hollow, as shown in FIG. 6B, a largest sphere may include a diameter in the range of 3-5 mm with a solid portion of roughly 1-2 mm around the sphere.

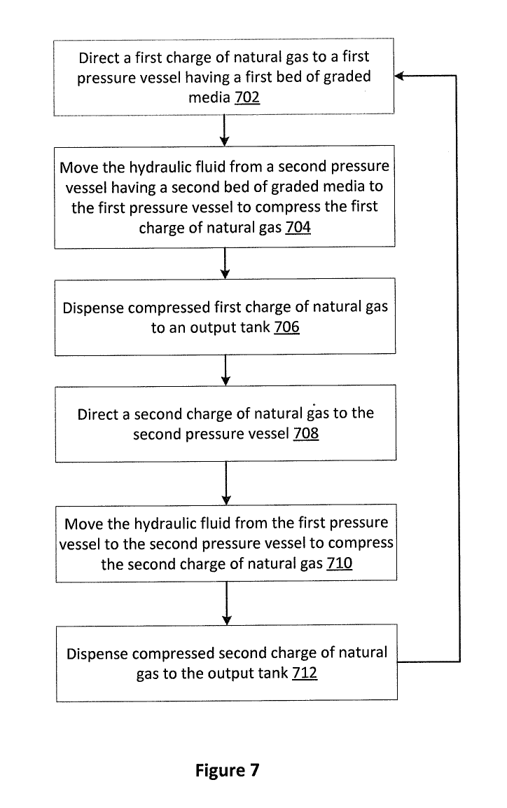

Referring now to FIG. 7, an example flow chart depicting a method 700 for gas compression is shown. In general, the method 700 is one example of a method for compressing gas. Although the method 700 will be described utilizing components illustrated in FIGS. 1-6, it is understood that such description is non-limiting.

The method 700 begins at operation 702 where a first charge of natural gas is directed to a first natural gas input line to a first pressure vessel having a bed of graded media. For example, utilizing the system 200, a first charge of natural gas may be directed from the natural gas supply 216 to the first pressure vessel 202. In particular, the natural gas contacts the graded media positioned within the first pressure vessel 202. During the first operation, the first pressure vessel 202 does not contain a substantial amount of hydraulic fluid and a second pressure vessel having a second bed of graded media is substantially filled with hydraulic fluid.

Next, the method 700 moves to operation 704 where the hydraulic fluid is moved from the second pressure vessel to the first pressure vessel. For example, the hydraulic fluid is directed from the second pressure vessel 204 to the first pressure vessel 202 in an effort to compress the gas that is positioned within the first pressure vessel 202. As the hydraulic fluid fills the first pressure vessel and compresses the first charge of natural gas, heat results. The bed of graded media assists in the absorption of this heat. In particular, the graded media may be spherical with the media having smaller diameters positioned at the top of the first pressure vessel. In this way, the media having greater surface area and higher concentration of thermal mass, and thus the greatest ability to absorb heat, is positioned at the area of highest compression.

When the pressure of the natural gas in the first pressure vessel exceeds the pressure in the CNG tank, the system directs the compressed natural gas to the CNG tank during operation 706. In some embodiments, the output tank may be a CNG tank within or located near a natural gas vehicle. In other embodiments, the output tank may be any tank that is suitable to hold a volume of compressed gas.

The method 700 then moves to operation 708 where a second charge of natural gas is directed through a second natural gas input line to the second pressure vessel having the second bed of graded media. Because the second pressure vessel 204 is emptied in the operation 704, it is now ready to receive the second charge of gas from the natural gas supply 216. The natural gas flows through an alternate path, the second natural gas input line, into the second pressure vessel 204, where it awaits compression.

The method 700 next proceeds to operation 710 where the hydraulic fluid is moved from the first pressure vessel to the second pressure vessel. The hydraulic fluid is moved in an effort to compress the second charge of gas residing in the second pressure vessel 204. Similarly as stated above, the graded media within the second pressure vessel act to absorb a majority of the heat created in the compression process.

When the pressure of the natural gas in the second pressure vessel exceeds the pressure in the CNG tank, the system directs the compressed natural gas to the CNG tank during operation 712.

At this point, the method 700 may end if a desired volume of gas has been moved to the CNG tank and he pressure in the CNG tank has reached a desired level (3.g., greater than 1500 psi. However, if a desired amount of gas has not yet been compressed, the method proceeds back to operation 702. The alternating cycle continues until a desired amount of pressurized gas fills the CNG tank.

It is understood that the above-described system is applicable in any situation where high compression rates are desired. Though the system is described herein as utilizing a natural gas, it is further understood that the system may pressurize any gas or mixture of gases, including, for example, air, fuel gas, hydrogen, or the like.

1. A system for compressing gas, the system comprising:
a source of gas;
a gas output location;
first and second pressure vessels;
first and second gas input lines for directing gas from the source of gas respectively to the first and second pressure vessels;
first and second gas output lines for directing gas respectively from the first and second pressure vessels to the gas output location;
a hydraulic system for moving hydraulic fluid back and forth between the first and second pressure vessels to compress gas in the first and second pressure vessels in an alternating manner, wherein gas is pressurized in the first pressure vessel by directing a first charge of gas from the source of gas into the first pressure vessel through the first gas input line and moving hydraulic fluid from the second pressure vessel to the first pressure vessel to compress the first charge of gas within the first pressure vessel, and wherein gas is pressurized in the second pressure vessel by directing a second charge of gas from the source of gas into the second pressure vessel through the second gas input line and moving hydraulic fluid from the first pressure vessel to the second pressure vessel to compress the second charge of gas within the second pressure vessel; and
and wherein a heat absorbing media is positioned within the first and second pressure vessels to control an amount the gas increases in temperature during compression.

2. The system of claim 1, wherein the heat absorbing media has a surface area to unit volume ratio that is variable.

3. The system of claim 2, wherein the surface area to unit volume ratio varies along a gradient.

4. The system of claim 2, wherein each of the first and second pressure vessels has at least first and second zones where the heat absorbing media has different surface area to unit volume ratios.

5. The system of claim 2, wherein the surface area to unit volume ratio of the heat absorbing material is higher adjacent higher pressure regions of the first and second pressure vessels as compared to lower pressure regions of the first and second pressure vessels.

6. The system of claim 2, wherein the surface area to unit volume ratio of the heat absorbing material is higher adjacent the first and second gas output lines of the first and second pressure vessels as compared to away from the first and second gas output lines.

7. The system of claim 2, wherein the heat absorbing media includes a plurality of heat absorbing members, and wherein cross-dimensions of the heat absorbing members are varied at different regions of the first and second pressure vessels to vary the surface area to unit volume ratios.

8. The system of claim 7, wherein the heat absorbing members include at least one of: pellets, elements, pieces, and units.

9. The system of claim 8, wherein the heat absorbing members are spherical.

10. The system of claim 7, wherein the heat absorbing members are hollow.

11. (canceled)

12. (canceled)

13. (canceled)

14. (canceled)

15. (canceled)

16. (canceled)

17. (canceled)

18. A method for compressing gas, the method comprising:
directing a charge of gas to a pressure vessel having a bed of heat sink media;
moving hydraulic fluid into the pressure vessel to compress the gas; and
absorbing heat of compression with the heat sink media as the gas is compressed.

19. The method of claim 17, wherein the heat sink media is spherical and hollow.

20. The method of claim 17, wherein the gas is compressed with a compression ratio of greater than 200 to 1.

21. (canceled)

22. The method of claim 17, wherein the heat sink media has a surface area to unit volume ratio that is variable.

23. (canceled)

24. The method of claim 22, wherein the surface area to unit volume ratio varies along a compression curve.

25. (canceled)

26. The method of claim 17, wherein the heat sink media has an average particle size that varies at different locations of the pressure vessel.

27. A pressure vessel in a compression system, the pressure vessel comprising:
a heat sink media contained in the pressure vessel;
the pressure vessel arranged and configured to receive a charge of gas and a volume of hydraulic fluid, wherein the volume of hydraulic fluid compresses the charge of gas thereby resulting in an output of heat, and wherein the heat sink media absorbs a portion of the heat and releases the portion of the heat into the hydraulic fluid.

28. The pressure vessel of claim 27, wherein the heat sink media has a surface area to unit volume ratio that is variable.

29. (canceled)

30. (canceled)

31. The pressure vessel of claim 28, wherein the heat sink media has a higher surface area to unit volume ratio adjacent to a higher pressure region of the pressure vessel as compared to a lower pressure region of the pressure vessel.

32. (canceled)

33. The pressure vessel of claim 28, wherein the heat sink media includes particles shaped in at least one of: wires, spheres, saddles, hexagons, squares, and rectangles.

34. (canceled)
